(19) United States
(12) Patent Application Publication
(10) Pub. No.: US 2021/0357969 A1
(43) Pub. Date: Nov. 18, 2021

(54) MULTI-ACTION TRANSACTION SYSTEM AND METHOD

(71) Applicants: Sean Anthony EDMISTON, New South Wales (AU); David Kenneth EHRLICH, New South Wales (AU); MOBILE TECHNOLOGY HOLDINGS LIMITED, Douglas (IM)

(72) Inventors: Sean Anthony Edmiston, Tintenbar, NSW (AU); David Kenneth Ehrlich, Dolls Point, NSW (AU)

(21) Appl. No.: 17/050,175

(22) PCT Filed: Apr. 17, 2019
(86) PCT No.: PCT/AU2019/050345

§ 371 Date: Oct. 23, 2020

Related U.S. Application Data
(60) Provisional application No. 62/661,084, filed on Apr. 23, 2018.

(51) Int. Cl. G06Q 30/02; G06Q 20/20; G06Q 20/38; G06Q 20/32

(52) U.S. Cl. CPC G06Q 30/0233; G06Q 20/208; G06Q 20/3827; G06Q 20/3274; G06Q 20/3829

(57) ABSTRACT

A transaction system and method, for use at merchant premises and which includes an electronic cash register (182, 54) and a scanning device (184, 60). The scanning device (184, 60) optically scans a customer code (198) on a user device (48), such as a user's smart phone (148). The customer code (198) is processed (188) using a plurality of keys to produce a plurality of processing tokens (181, 183,185), such as a financial processing token and a loyalty program token. These tokens can then be used to initiate multiple actions, such as transaction payment and loyalty program actions, from a single scan (184) of the customer code (198). The processing tokens (181, 183, 185,) may be provided to respective token vaults (192, 194, 196) for conversion to respective account numbers, e.g. for a financial account and a loyalty program account.

### FIELD OF THE INVENTION

This disclosure relates primarily, though not exclusively, to systems and methods for conducting financial transactions. In particular, this disclosure relates to systems and methods for conducting transactions at a merchant premises utilizing a reader and an electronic cash register, whereby a customer code, provided on a user device is scanned, and then, using a plurality of keys, a plurality of tokens are produced. The tokens preferably include a financial transaction token and a loyalty program token such that both financial and loyalty transactions are facilitated.

### BACKGROUND OF THE INVENTION

Tokenization has become a popular method for enabling mobile devices to be used directly in a transaction. In a typical tokenization method, a user downloads a payment application (app), e.g. Apple Pay, issuing bank app, etc. to their mobile device and then enters their credit card details into the payment app. The payment app then contacts the issuing bank which issues a token to the payment app. The token is a substitute or surrogate for the Primary Account Number (PAN) of the user's credit card. Typically, the token is a number having the same form as the credit card number, e.g. 16 digits. Thus, the token appears as a valid PAN but cannot be used directly in a transaction. The payment app and/or issuing bank stores the PAN and associated token in a secure data store termed a token vault. The token will typically be in a Bank Identification Number (BIN) range of the token vault which may be different to the BIN range for the issuing bank. The token is pushed to the user's device and the user device thus stores only the token, not the original PAN or other credit card information.

When a transaction is to be conducted, the user invokes the payment app and provides their token to a merchant reader, e.g. using near-field communications protocols. The token and the transaction details are then passed by the merchant systems into a transaction processing system during which a call is made to the token vault to retrieve the PAN associated with the token. The issuing bank is then able to authorize the transaction.

Tokenization offers many security benefits. In addition to the mobile device not storing credit card details, the merchant need only store tokens, rather than credit card details, and tokens themselves can be made merchant specific. Thus, if a merchant's system is hacked or otherwise compromised, only the tokens for that merchant need to be replaced. The issuing bank does not need to cancel and reissue the PAN.

While tokenization offers many security benefits, a problem remains that the issuing bank still needs to provide the user a card detailing the Primary Account Number. This can be problematic if the security of the card becomes compromised. Furthermore, the token can only be used in mobile devices that have installed appropriate payment apps and can communicate tokens via near-field communications protocols. This can limit the range of transactions in which the mobile transaction system is deployed.

Furthermore, because the token is associated with a single account number, there is only one action that can be taken using the token. To perform multiple actions in a single transaction, the customer needs to provide multiple tokens. This is inconvenient not only for the customer, but also the merchant because it increases the amount of time for conducting the transaction and can increase the hardware required for processing multiple tokens.

This therefore identifies a need for an improved system and method for conducting financial transactions.

### SUMMARY OF THE INVENTION

In a transaction system, such as at a merchant device of a merchant premises, a device may be provided to obtain a customer code from a customer, for example by optically scanning a code displayed on the customer's mobile phone or other device. The customer code is processed by the device using a plurality of keys to produce a plurality of processing tokens, such as a financial processing token and a loyalty program token. These tokens can then be used to initiate multiple actions, such as transaction payment and loyalty program actions, from a single scan of the customer code. The processing tokens may be provided to respective token vaults for conversion to respective account numbers, e.g. for a financial account and a loyalty program account.

In one aspect of the disclosure, there is provided a transaction method. In the method, a customer code may be obtained from a customer at a merchant system during a transaction at the merchant system. The customer code may be processed, at the merchant system, using a plurality of keys into a plurality of processing tokens. At least two actions may then be initiated from the merchant system using the plurality of processing tokens.

In one aspect of the disclosure, there is provided a merchant system including an electronic cash register and at least one reader device operatively connected to the electronic cash register. The reader device may be programmed to obtain a customer code during a transaction of the merchant system. When then reader device obtains a customer code, it processes the code using a plurality of keys to produce a plurality of processing tokens. The electronic cash register may use the plurality of processing tokens to initiate at least two transaction actions for the transaction.

The above description sets forth, rather broadly, a summary of some embodiments of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

Reference will now be made, by way of example only, to specific embodiments and to the accompanying drawings in which:

FIG. 1 shows a mobile phone device displaying an optically scannable code;

FIG. 2 shows a system and process for provisioning bCODE/processing token pairs;

FIG. 3 shows a system and process for conducting a financial transaction using an optically scannable code;

FIG. 4 shows an embodiment of a scanner;

FIG. 5 shows a method for provision bCODE/processing token pairs and delivery bCODEs to users;

FIG. 6 shows amethod for conducting a financial transaction using an optically scannable code;

FIG. 7 shows a system and process for provisioning bCODEs as gift cards;

FIG. 8 shows amethod for provisioning bCODEs as gift cards;

FIG. 9 shows a system and process for using bCODEs for a loyalty/coupon program with a CRM integrated into an ECR;

FIG. 10 showsa method for uses bCODEs for a loyalty/coupon program with a CRM integrated into an ECR;

FIG. 11 shows a system and process for using bCODEs for a loyalty/coupon program without a CRM integrated into an ECR;

FIG. 12 showsa method for uses bCODEs for a loyalty/coupon program via a POS terminal;

FIG. 13 shows a system using an aggregation service for multiple loyalty programs;

FIG. 14 shows a method using an aggregation service;

FIG. 15 shows a system for using bCODEs representing BIN range processing tokens in an online shopping embodiment;

FIG. 16 shows a multi-action transaction method in which a single customer code can be processed by multiple keys;

FIG. 17 showsa process for generating multiple processing tokens from a customer code at a merchant system; and,

FIG. 18 shows a system for provisioning a customer code into multiple processing tokens.

### DETAILED DESCRIPTION OF PREFERRED EMBODIMENTS

In WO2005/083640 and WO2006/060849, the entire contents of each of which are incorporated herein by reference, the Applicant has described a system and method by which coded information may be distributed to users in an optically scannable text-based code via text messaging. The Applicant has further described how such optically scannable codes, termed in the Applicant's proprietary language as bCODEs, can be scanned and processed by relatively simple optical scanners.

In the Applicant's co-pending patent application entitled “Transaction System and Method”, claiming priority of US Provisional Patent Application No. 62/661081, there is described a system and method by which optically scannable codes which can be delivered to users via text message services such as SMS, email, etc. can be used as surrogates for processing tokens (tokens used in transactions for representing Primary Account Numbers (PAN)s such as credit card numbers, loyalty program identifiers etc.).

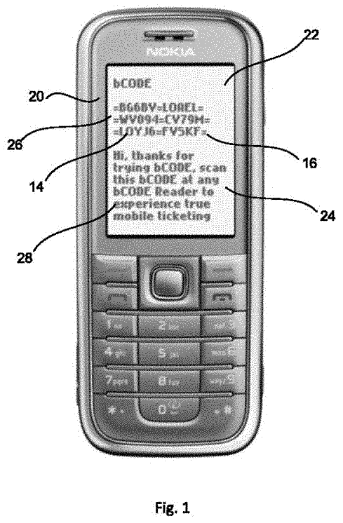

FIG. 1 shows the screen of a mobile telephone device displaying an example of an optically scannable text based customer code. The customer code may be generated as a customer code/processing token pair. In one non-limiting embodiment, the customer code may be generated and then a cryptographic one-way hash may be performed on the customer code to create a processing token having a required form. In the case of a credit card token, the required form will be a 16 digit number within a BIN range for the token vault. The customer code/processing token pair may be stored in the token vault and at some point, the customer code/processing token pair may be associated with a PAN, such as a credit card number, account number, etc. in the token vault.

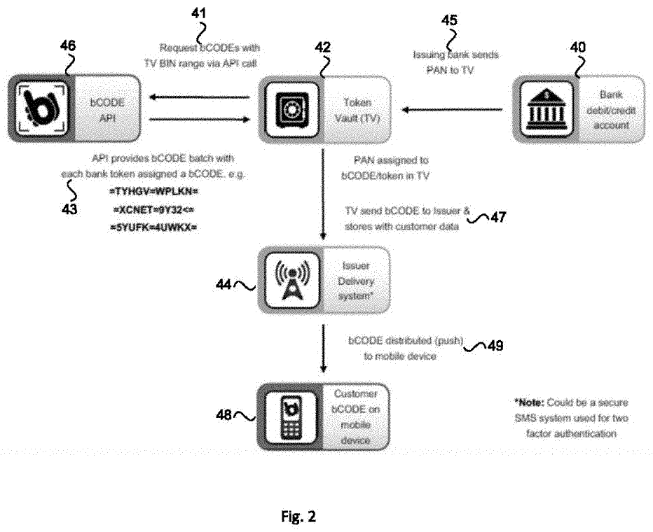

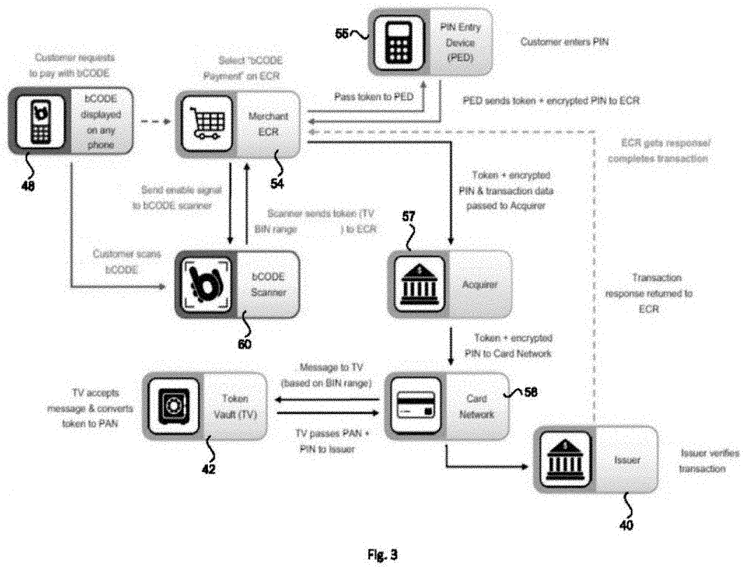

FIGS. 2 and 3 show a system and process for provisioning a customer code/processing token pair, for associating the provisioned pair with a PAN, and for conducting transactions. The description henceforth shall make specific reference to the customer codes using the Applicant's proprietary bCODE terminology, however it is to be understood that the embodiments are not intended to be limited to bCODEs and that other forms of customer codes or similar identifiers could be employed.

Payment, loyalty and other transactions may be supported for all mobile devices using either direct delivery (e.g. SMS, messaging service such as WhatsApp/Facebook Messenger, etc.), or delivery via an issuers wallet or a third party wallet.

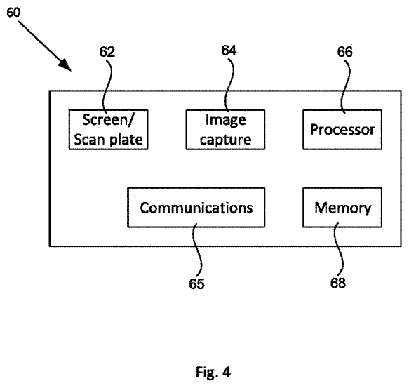

Transactions to be herein described with particular reference to FIGS. 2 and 3 may use the following optional additions to existing systems:
each issuer 40 to have access to a customer code (bCODE) enabled token vault 42;
issuer's system 40 updated to add the bCODE enabled token vault 42;
issuer's system 40 updated to add bCODE delivery 44;
issuer's mobile app updated to support both requesting a bCODE for payment and delivery of the bCODE to the app;
bCODE Scanner 60 (FIG. 4) installed as part of the merchant system on the counter and connected to either ECR or POS terminal 54;
electronic Cash Register (ECR) 54 or Point of Sale (POS) terminal software updated to accept bCODE scanner input (e.g. via USB);
if POS connected, POS software modified to treat input from scanner 60 as payment token in normal transaction flow;
if ECR 54 connected, ECR software modified to treat input from scanner 60 as payment token and pass to a PIN Entry Device (PED) 56 for PIN capture.

PED software modified to accept token from ECR 54 and capture PIN and process as in a normal transaction flow. This may require PCI recertification for some PED devices.

Additional work items for payments via third party applications (e.g. wallets):
wallet is updated to call the bCODE token vault 42 after capturing the users PAN via existing methods;
wallet is updated to capture response from bCODE token vault (bCODE) and push the bCODE back to the user for display.

The system requires additional elements including a bCODE token vault 42 and a bCODE delivery system 44.

A bCODE enabled token vault 44 is a regular token vault modified so that two tokens are created for each PAN. The first token (the processing token) may be exactly the same as existing bank identification number (BIN) range tokens. The second token (the customer token, delivery token, customer code, etc.) is a string formatted according to the bCODE standard and is used for delivery to the mobile device. The bCODE token vault 44 stores an association between the PAN, the processing token and the bCODE. The bCODE enabled token vault 44 can be run by the issuer 30 or a third party entity and made available to issuers as a new service to simplify the work required by the issuer to support bCODE.

The bCODE delivery system 44 delivers the bCODE text to the user. In one embodiment, a basic delivery system includes a simple SMS aggregator integration to send bCODE text via SMS to MSISDNs. A more sophisticated system would support sending the message to one of a number of ‘contact handles’ (e.g. twitter handle, MSISDN, email) via one of a number of channels (e.g. SMS, WhatsApp, Twitter DM, email, mobile pass format). The delivery service has many parallels with systems used today for ‘two factor authentication’ (2FA) codes and many 2FA systems are easily upgraded to support bCODE delivery. The delivery system may be run by the issuers themselves, or by a third party.

The bCODE scanner is a scanner that is configured to optically scan, i.e. image capture, delivery tokens such as bCODEs or other forms of optically scannable codes. The scanner is further configured to perform an optical character recognition process to extract from the captured image the data contained within the bCODE and to further process the bCODE to obtain a processing token. An embodiment of the scanner 60 is shown in FIG. 4.

Scanner device 60 form factor details may vary depending on the application and details of embedding of the scanner apparatus as part of existing equipment. The scanner device 60 will include a housing that contains the components of the scanner. The housing may be shaped to clip, bolt or otherwise connect to external devices such as an ECR, PCS terminal, customer interface device (e.g. self-checkout machine), etc. Alternatively, the scanner 60 may be a standalone device, similar to the scanner kiosk described in the Applicant's earlier patent applications referenced above.

With reference to FIG. 4, the scanner 60 may include a screen and/or scan plate 62 and image capture component 64 (e.g. digital camera) through which an image of a phone screen displaying a bCODE message may be captured. The image capture component 64 may additionally include a proximity sensor, such as an infrared sensor beam (not shown) to trigger the acquisition of an image by the digital camera 64.

The scanner 60 includes computing components including at least one processor 66 and operatively associated memory 68, for example in the form of a single board computer. The memory 68 may include memory for storing executable instructions, programs, applications, data storage etc. as well as accessible memory for use during execution of programs and instruction sets. The software stored and executed by the computing components will include OCR software for extracting text characters from the captured image, bCODE software for determining the form of the bCODE, and additional keys, algorithms and software for processing the bCODE into at least one processing token.

The specific form of the processor and memory is subject to change with technological innovations in the computing art and thus the specific form of the computing components is not considered to be pertinent to the present embodiments.

A communications module 65 may include one or more communications ports, as well as programmed protocols for communicating information to external devices. In one embodiment, the communicationsmodule 65 may include at least one Universal Serial Bus (USB) port for connection to external devices such as an ECR or POS terminal. USB is one form of communications though other forms of communications, by either wired or wireless protocols, will be apparent to the person skilled in the art. In other embodiments, the scanner may be configured for Local Area Network (LAN) communications. Wide Area Network (WAN) communications, internet communications, mobile network communications, etc. The particular method by which the scanner 60 communicates with external devices such as the ECR or POS terminal is not considered to be pertinent to the present embodiments.

In addition to optical scanning, the scanner 60 may include additional components for reading bCODEs bCODE through non-optical means, such as via Near-Field Communications (NFC), Bluetooth, etc.

The digital camera 64, optionally triggered by a proximity detector (not shown), may be used to scan or otherwise capture an image of the mobile phone screen presented at the scan plate 64. Typically, the user will have arranged their phone to display a bCODE message so that when the image of the mobile device is captured, the message displayed on the screen including the bCODE, will also be captured.

Decoding may be performed by segmenting the bCODE from the acquired image and applying optical character recognition (OCR) to obtain a raw bCODE. The scanner may be programmed with keys for generating processing tokens from scanned bCODEs using the same hash algorithms and keys employed to initially generate the processing tokens in the token vaults.

Prior to payment capability, the bCODE must be provisioned. This includes generating the bCODE/processing token pair, associating a user's PAN with a bCODE delivery token and BIN range processing token in the bCODE token vault and notifying the user of the bCODE for storage of the bCODE on the user's mobile device.

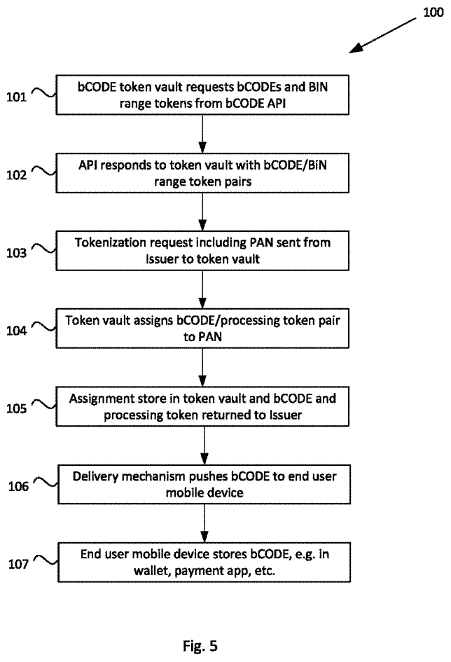

The provisioning process is illustrated in FIG. 2 and the flowchart 100 of FIG. 5. At step 101, the bCODE enabled token vault 42 makes a call 41 to the bCODE API 46. The call includes the Issuer's token vault BIN Range (e.g. 3276) and number of tokens required (e.g. 500,000 bCODEs). The request for bCODEs can happen in bulk and ahead of time, so that the token vault always has tokens and bCODEs available for PAN assignment requests. In one embodiment, the bCODE API 46 creates bCODE values that can be assembled into delivery token messages for delivery to users. For each bCODE value, the API 4 6 performs a cryptographic one way hash using a programmed key to generate an associated processing token value for the bCODE within the token vault BIN range. The bCODE API responds 43 (step 102) with bCODE/processing token pairs, e.g.:

$$PAN like Token in TV BIN Range ( e . g .327 \; 6 \; 1234 \; 5678 \; 9101 )$$

$$Matching bCODE , \\ e . g . = AB ODE = AB c DE == 12345 = XYZAB == LMPR 1 = XXXXX =$$

A step 103, a token request 45 is triggered by the Issuer 40 according to their own business rules. For example, a customer could request a mobile payment by making a selection in the Issuer's mobile banking app, or tokens could be pushed out to existing Issuer customers. For third party wallets, the token request is triggered when the PAN (e.g. credit card number) is entered by the end user. The Issuer request 45 to the bCODE enabled token vault 42 includes the PAN and a request for a processing token. Token vaults may be different for different PANs-e.g. Visa PAN (4511 1234 5678 9023) may be required to go to Visa token vault. If a particular PAN, e.g. VISA PAN, is required to be tokenized using a prescribed or mandated token vault (e.g. VISA token vault) that does not support bCODE, then the PAN is passed to the prescribed token vault first (e.g. VISA token vault), and then the token from that prescribed vault, e.g. a VISA token, is passed to the bCODE enabled token vault 42 as the PAN. The processing token thus stored in the bCODE token vault may be considered as a pointer to the actual processing token stored in the prescribed token vault.

In response to receiving the PAN tokenization request 45, the bCODE token vault 42 selects one of the previously provisioned bCODE/token pairs and assigns it to the PAN (step 104). The association of the PAN with the bCODE and processing token are stored in the token vault 42 and a bCODE is returned 47 to the Issuer along with the normal processing token (step 105). The Issuer stores the bCODE as they would the normal token.

The Issuer then invokes a bCODE delivery mechanism by sending the bCODE, contact handle and method of communication to a bCODE delivery service 44. At this point, the bCODE may be formatted into an optically scannable message with framing characters “=” separating the text characters of the bCODE to aid in scanning and optical character recognition, e.g.

$$= AB C DE = AB C DE == 123 \; 45 = XYZAB == LMPR 1 = XXXXX = twitterhandle Twitter DM$$

The delivery service transmits the formatted bCODE to the end user (step 106) by the specified delivery method. At step 107, the received bCODE is received into the user/customer's mobile device 48 where it can be stored as appropriate. In the case of a mobile app (Issuer app or third party wallet), the bCODE is delivered directly to the app via push notification as an alternative method of delivery.

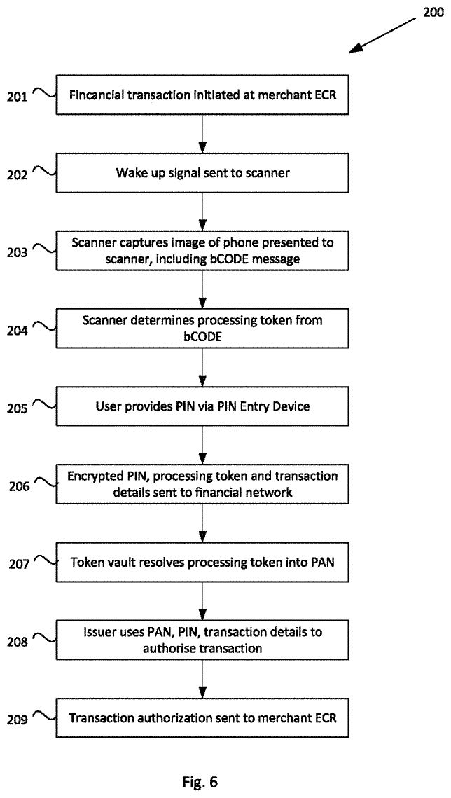

Once the bCODE has been provisioned in the token vault and supplied to the user device 48, the user may then use the bCODE in financial transactions. A financial transaction method is depicted in FIG. 3 and the flowchart 200 of FIG. 6.

A user initiates a mobile device transaction at a merchant point of sale that is configured with a bCODE scanner 60 or similar reader (step 201). The merchant's ECR 54 sends an ‘enable’ signal to the bCODE scanner 60 to wake it up (step 202). The scanner shows a red scan illumination to indicate to the customer where to scan. The bCODE device 60 connects to the ECR 54 via USB, using USB HID keyboard or JPOS protocols. Other wired or wireless connections and communications protocols will be apparent to the person skilled in the art. At step 203, the scanner 60 scans the bCODE from the user device 48. The scanner 60, being programmed with appropriate bCODE processing algorithms, such as the same cryptographic one way hash and key used by the API 46 in the original provisioning process, converts the bCODE into a BIN range token (processing token) (step 204) and sends the processing token to the ECR 54. For example, a bCODE token:

$$= AB C DE = AB C DE == 123 \; 45 = XYZAB == LMPR 1 = XXXXX =$$

may be converted to:
3276 1234 5678 9101.

The ECR 54 then passes the BIN range token to a PIN Entry Device (PED) 55 coupled to the ECR and the customer enters the PIN on the PED 55 (step 205).

The PED 55 sends the processing token and encrypted PIN to the ECR (e.g. using industry standard PIN Block formats).

At this point in the transaction flow, the ECR 54 has received a conventional token based transaction request including transaction value, payment token and encrypted PIN. All the subsequent steps require no modification from existing token based financial processes but are described herein for clarity. A person skilled in the art will readily understand that some or all of these steps may be modified or omitted as required, depending on the particular transaction and parties involved.

At step 206, the PCS passes the processing token, encrypted PIN and transaction details into the financial network, starting with an Acquirer 57. The Acquirer 57 passes the processing token, encrypted PIN and transaction details to the Card Network 58 which passes the token, encrypted PIN and transaction details to the token vault 42, routing the token to the appropriate token vault based on the token BIN range.

The token vault 42 looks up the processing token and converts the processing token to the associated PAN (step 207), which is sent back to the network 58 (with encrypted PIN, token vault and transaction details).

In the case that the processing token was generated from a brand mandated token and thus the token stored in the bCODE token vault is a pointer to the prescribed token vault, this step will convert the bCODE processing token into the card brand token, rather than the actual PAN. However, when the network sees this message it will simply see the card brand token and pass the card brand token to the card brand token vault which will convert the card brand token to the final PAN and back to the network.

The Network 58 passes the final PAN, encrypted PIN and transaction details to Issuer 40 who validates the transaction (step 208) and returns the response to network 58.

The above method describes how a bCODE or similar customer code can be carried by a user in their mobile phone and used to identify the user to a merchant terminal for financial transactions, with the merchant terminal being programmed to convert the customer code to a processing token for use in the financial transaction. In a similar manner, and as described in the Applicant's co-pending patent application, referenced above, a bCODE can be used as a customer identifier to identify a user to a merchant terminal for Customer Relationship Management (CRM) aspects of a transaction including loyalty program processing and gift cards. CRM may require the following additions to the existing systems described above that support bCODE payments:
bCODE support is added to the existing system that the gift card provider uses to generate BIN range values for gift cards. This is the same as adding a bCODEs field to a payment token vault to create bCODE/gift card token pairs as described previously.
gift card provider adds support to store the bCODE (if this is a separate system to the previous one).
bCODE delivery can be managed either by the originating brand CRM or the gift card provider.

If managed by the gift card provider, then the gift card provider must integrate with a bCODE delivery service and the brand CRM has to provide the gift card provider with contact handle and method of delivery.

If the brand CRM is managing delivery, this improves customer data security, since it is no longer necessary to provide the gift card provider with any contact details for the end customer. In this case, the brand CRM may integrate with a bCODE delivery system and pass the bCODE provided by the gift card provider to the delivery system.

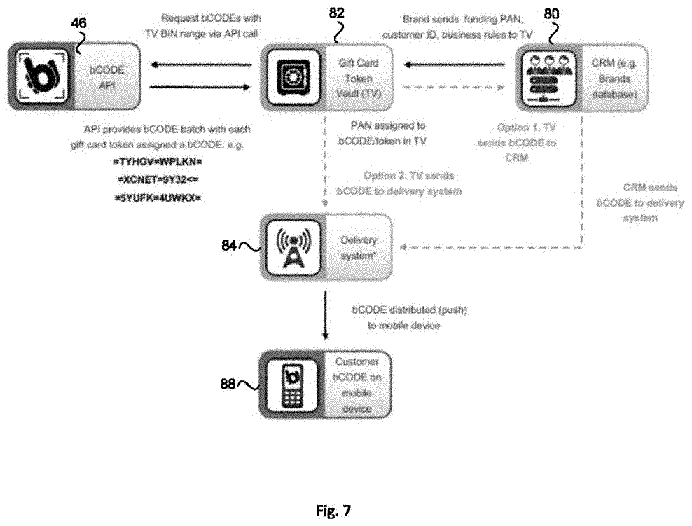

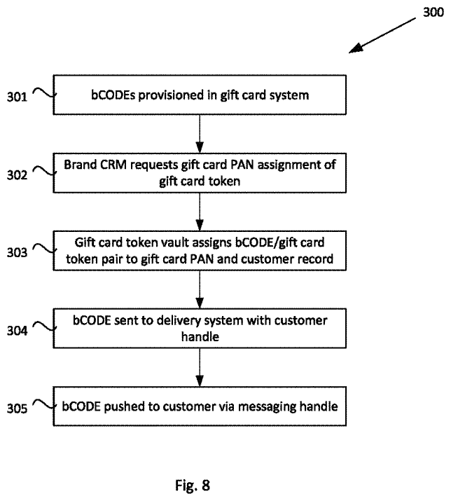

FIG. 7 and the flowchart 300 of FIG. 8 show a process by which BIN range based (open loop) gift cards and rewards can be transacted using bCODE. BIN range based gift cards are requested by a brand CRM (or similar system).

At step 301, bCODEs are provisioned into the gift card provider's system 80 in a manner similar to that for bCODE payments described previously. That is, bCODE and gift card token pairs may be provisioned in a gift card token vault 82 by first making a call to a bCODE API 46 for a specified number of bCODE/token pairs within a gift card token vault BIN range.

When a gift card is required, the brand CRM 80 sends a request to the gift card provider with customer identifier (step 302). This request includes details such as the real PAN that is financing the cards (or a surrogate thereof), and any rules about what is allowed (e.g. only purchases under $100, or only a total of $50 of purchases per customer before August 31).

The gift card provider requests a bCODE and Token pair from the gift card token vault 82 with the customer identifier. The gift card token vault 82 understands the payment rules for the gift card and knows what the real PAN is and under what conditions to forward the transaction request to the original PAN issuer for approval/transaction completion. The gift card token vault 82 assigns the bCODE/token pair to the PAN and customer record (step 303).

The bCODE gift card delivery (step 304) is much simpler and more scalable than traditional gift card delivery which opens new approaches to distribution. In a first approach the customer contact details are passed to the gift card provider and the gift card provider manages the delivery of the bCODE to the end customer. The second approach is that the gift card provider simply passes back a bCODE to the brand CRM and then the brand CRM system integrates with a bCODE delivery service to deliver the bCODE. The benefit of this approach is improved end customer data security since contact information is not shared with the gift card provider. A further option is for the gift card token vault, which is provided with the customer details, can provide the bCODE and customer handle to the delivery system.

The delivery system 84 pushes the bCODE to the mobile device 88 (step 305) via SMS, in app messaging, or by other methods similar to the payment methods described above.

bCODEs, once properly provisioned, can be used in merchant closed loop transactions. Merchant based closed loop coupons and loyalty fall into two types:
1. Merchants with modern ECR systems that are integrated with a CRM system and can understand loyalty and coupon identifiers, and
2. Merchants with ECR systems that are not integrated with a CRM system.
   Merchants with an ECR Integrated into their CRM

For these merchants, the ECR already knows how to scan and process a loyalty card, and send that information off to a CRM/Loyalty platform that knows what to do with it. This platform may be a third party. It may simply accumulate points in a third party platform or there may be responses defined and understood by the ECR. i.e. Loyalty/CRM platform passes response back to ECR that says this customer should have 10% deducted from bill.

Support for bCODE closed loop coupons and loyalty requires the following additional integration tasks:
coupon/loyalty platform integrates with bCODE API for provisioning of bCODEs;
coupon/loyalty platform is updated to allow coupons to be accessed by their bCODE token identifier;
coupon/loyalty platform integrates with a bCODE delivery system for delivery of bCODEs;
the bCODE scanner is integrated directly with the ECR in the same way as for payments;
ECR adds support for an additional operator button that enables the scanner when customer wants to scan a coupon or loyalty code and captures the bCODE token from the scanner and passes it back to the coupon/loyalty platform in the same way that they pass the existing loyalty card identifiers.

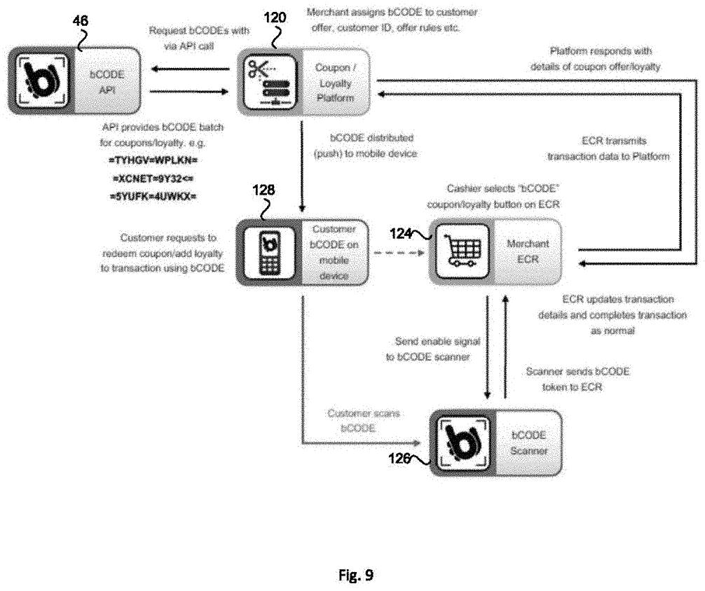

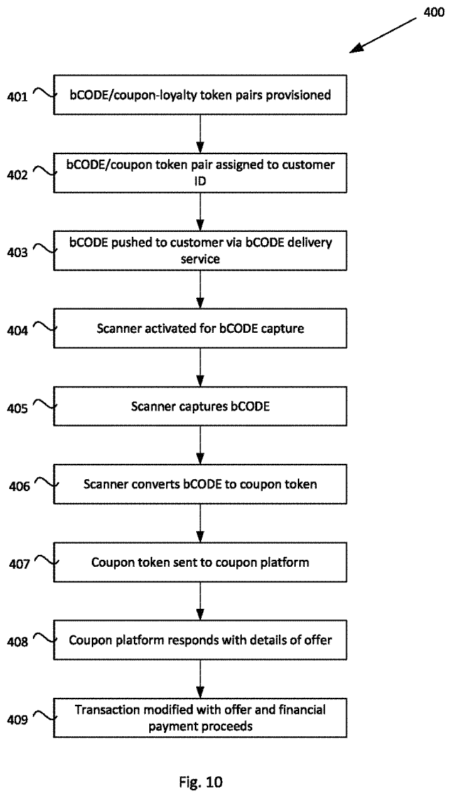

A process for handling closed loop coupons and loyalty, including prior provisioning, with ECR integrated CRM is shown in FIG. 9 and the flowchart 400 of FIG. 10.

At step 401, the Coupon/Loyalty platform 120 requests bCODEs and tokens, in bulk and in advance as for payments, via a call to the bCODE API 46. It should be noted that for coupon and loyalty programs, the tokens do not have to be BIN range format. A bCODE and token may be stored in coupon/loyalty system 120 and linked to a particular customer (step 402) and the bCODE may be sent to the enduser using a bCODE delivery service (step 403).

At some later transaction, the user indicates that they have a coupon/loyalty bCODE and the operator selects ‘bCODE Coupon/Loyalty’ button on ECR 124. For each third party coupon loyalty system that the merchantwants to support,an additional button may be added to the ECR 124. The operator may ask user what type of loyalty coupon it is and press the corresponding button. In response the ECR 124 activates the bCODE scanner 126 to accept a scan (step 404).

The user scans the bCODE 405 from their mobile device 128 and the scanner 126 converts the bCODE to a bCODE processing token and sends the bCODE processing token to the ECR 124 (step 406). The ECR 124 captures processing token and sends it to the coupon/loyalty system 407. The processing token is sent in the same way that existing loyalty card numbers are sent to the coupon/loyalty system. The coupon/loyalty platform 120 responds to the ECR 124 with details of the offer (e.g. reduce transaction total by 10%) 408 and the ECR 124 updates the transaction details and total accordingly and then proceeds with the transaction as normal 409, e.g. by then completing the financial payment aspects of the transaction.

Merchants with ECR systems that are not integrated with a CRM system

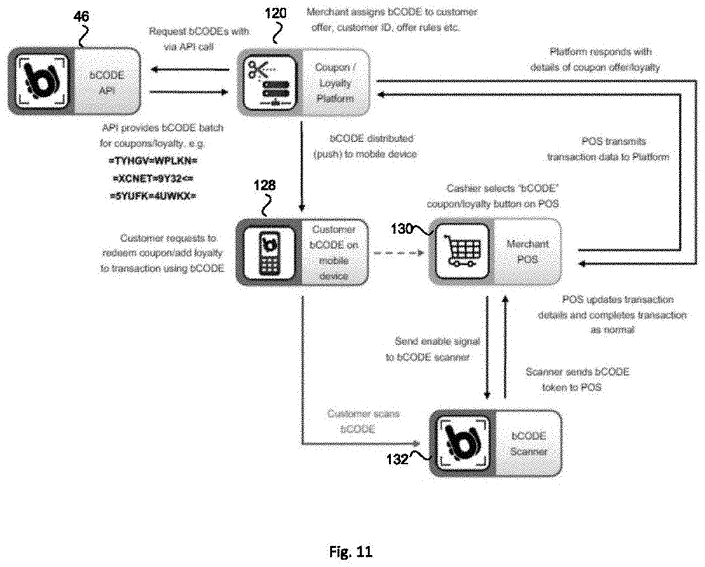

Merchants who do not have the ECR integrated directly with the CRM are still able to take advantage of coupon and loyalty features of independent CRM systems by integrating the bCODE scanner 132 (FIG. 11) directly with the credit card terminal (POS) 130. Coupons and loyalty offers through this method are more limited than when the ECR is directly integrated into the CRM. In particular, the CRM is not able to take advantage of specific details of the basket in the offer. For example, offering 50% off the purchase price of one brand of shampoo is not possible. Offering 5% reduction in the total transaction amount is possible.

Support for this method of bCODE closed loop coupons and loyalty requires the following additional integration tasks:
coupon/loyalty platform integrates with bCODE API for provisioning of bCODEs;
coupon/loyalty platform is updated to allow coupons to be accessed by their bCODE token identifier;
coupon/loyalty platform integrates with a bCODE delivery system for delivery of bCODEs;
the bCODE scanner is integrated directly with the POS in the same way as for payments;
POS adds support for an additional operator button that enables the scanner when customer wants to scan a coupon or loyalty code and captures the bCODE token from the scanner and passes it back to the coupon/loyalty platform.

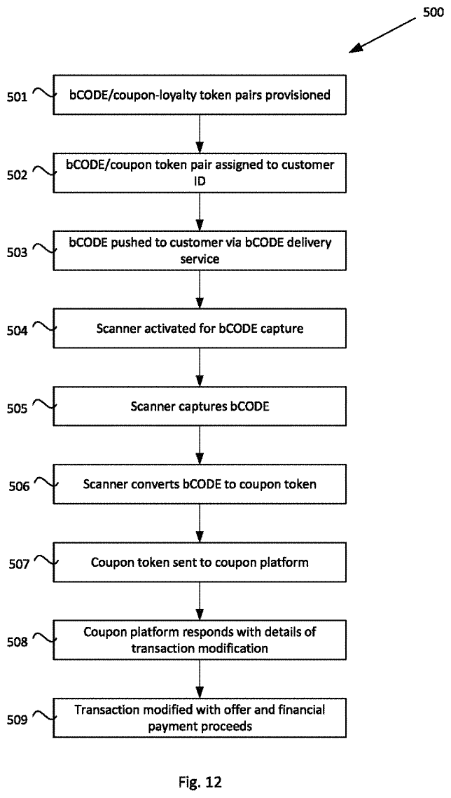

A process for handling closed loop coupons and loyalty, including prior provisioning, with bCODE scanner integrated into the POS terminal is shown in FIG. 11 and the flowchart 500 of FIG. 12.

Coupon/Loyalty platform requests bCODEs and tokens in bulk, in advance as previously described (step 501). Tokens do not have to be BIN range format. Pre-provisioned bCODE/token pairs can then be associated with end user's during a registration process (step 502), with the user details being stored in the token vault. The bCODE is sent to end user using bCODE delivery service (step 503).

During a transaction, the user indicates that they have a coupon/loyalty bCODE and the operator selects ‘bCODE Coupon/Loyalty’ button on POS terminal 130 which is modified to support input of a loyalty identifier. Multiple loyalty system support may require multiple buttons or a hierarchical menu to filter down to a particular loyalty system. The POS activates the bCODE scanner 132 to accept a scan (step 504) and the user scans the bCODE (step 505) from their device 128. The scanner converts the bCODE to a bCODE processing token and sends it to the POS 130 (step 506). The POS 130 captures the token and sends it to the CRM/loyalty system 120 for processing into a customer record and action response (step 507). The CRM loyalty/platform responds to the terminal with instructions on how to modify the transaction (step 508). An example response may be to reduce a transaction total by 10%. Options may be less for terminal based system since only a transaction total can be modified, rather than item specific actions.

At step 509, the terminal updates the transaction total and then proceeds with the transaction as normal.

While the present embodiments and examples describe that the scanner obtains the bCODEs through optical image capture and OCR resolution, the scanner is further described as having capability for receiving the bCODE from a mobile device via other techniques, including near-field communication data transfer using various protocols. For many of the embodiments and examples, the manner by which the scanner receives the bCODE from the mobile device is not essential and the person skilled in the art will recognize that the embodiments herein described are intended to capture within their scope other such data transfer methods.

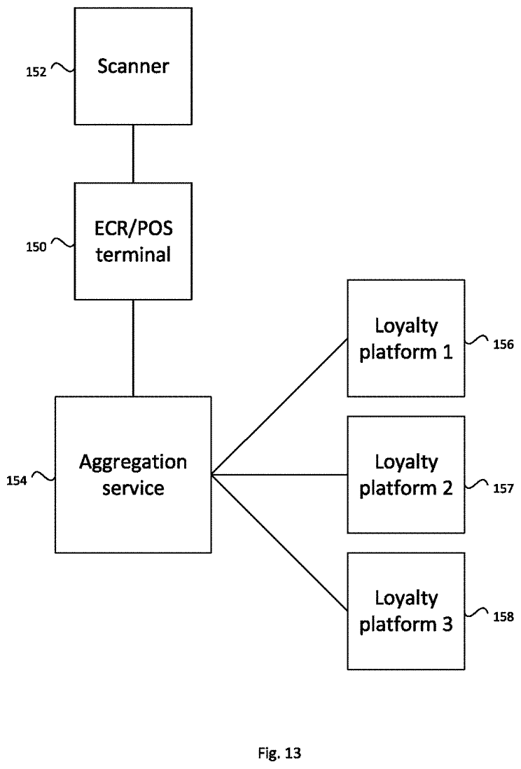

The use of a bCODE system as herein described can assist merchants in managing multiple third party coupon and loyalty programs. In order to avoid the integration and usability issues of the cashier having to press separate buttons for separate loyalty/coupon programs, an aggregation service can be provided. The bCODE system can already know what tokens belong to which loyalty platform via the API call of the provisioning process described above. So rather than ask the user and press a button before routing the loyalty/coupon token to the right platform, all tokens can be routed first to a central bCODE system 154 (FIG. 13) that handles loyalty transactions for multiple loyalty platforms 156,157,158. The aggregation service 154 determines which platform or token vault the token belongs to and forwards it on.

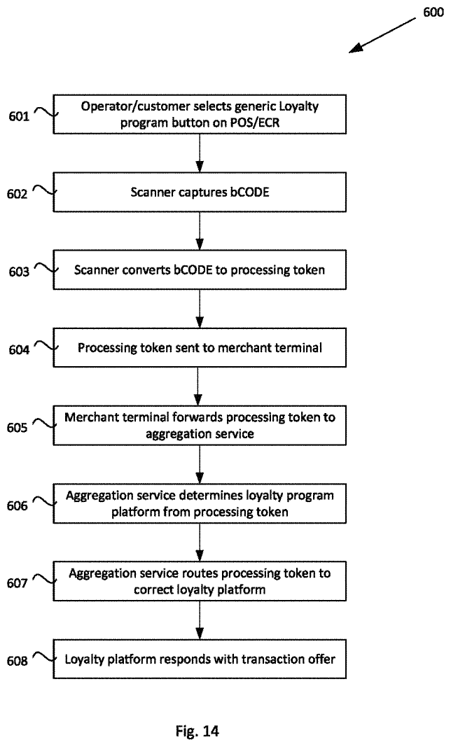

An embodiment of this process is shown in FIG. 13 and the flowchart 600 of FIG. 14. At step 601, the operator (which may be the user for self-checkout transactions) at the merchant terminal 150 either the ECR or PCS terminal, selects a generic loyalty program button that relates to multiple loyalty programs 156,157,158 handled by the aggregation service 154.

The bCODE scanner 152 then captures a bCODE from a device (step 602). The bCODE scanner 152 coverts the bCODE to a processing token (step 603) and sends it to the terminal 150 (step 604). The terminal 150 routes the token to a central bCODE token server (aggregation service) 154 (step 605) which processes the token to determine the token vault/platform in which the token is provisioned (step 606). The central server 154 forwards the token to the platform (step 607) where processing continues as described previously which responds with a transaction offer (step 608).

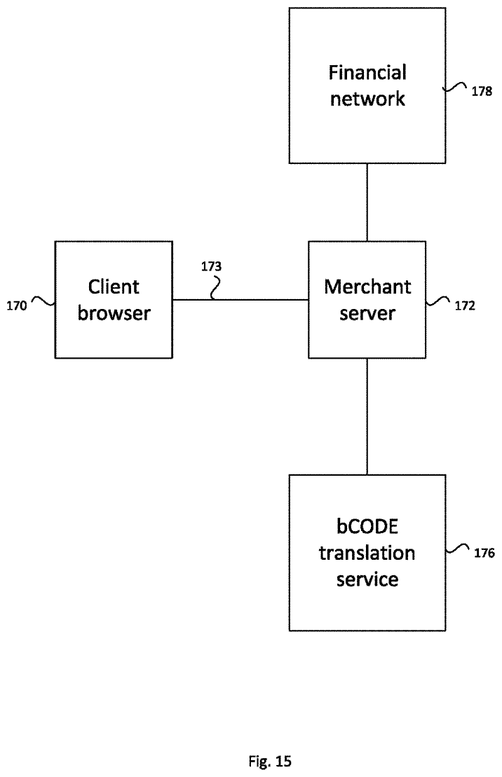

bCODEs issued as payment tokens represent valid BIN range tokens. Further, bCODEs, being optically readable alphanumeric character strings, can be read by the user and entered into online forms in a manner similar to credit card numbers from physical credit cards, but with added security that. This allows them to be used for online payments as well as offline payments. A web based merchant system is depicted in FIG. 15. In this system, a user at a client browser 170 can view an online shopping page presented by a merchant server 172 via a network connection such as the Internet 173. The client browser may be on the user's mobile device, or another computer terminal. For online payments it is necessary to have a means to convert the bCODE text available on the user's mobile device into the bCODE BIN range token at the merchant side. This can be done by:
asking the user to enter the bCODE text into one or more fields of a webpage form and then having the merchant web site pass the bCODE text to a bCODE translation service 17 6 to convert that into the bCODE BIN range token and then executing the transaction; or
asking the user to capture the bCODE text using their web cam and then passing that image via the merchant server to the bCODE translation service 176 to convert that image into the bCODE BIN range token.

In an alternative embodiment, the OCR processing of the image can occur in browser, or in the merchant server 172 so that the only information that is passed to the interpretation service 176 is the bCODE text.

In either case, the translation service 176 provides the interpretation function that was performed within the scanner in the previous embodiments in which the bCODE text was decoded into the associated processing token. Once the merchant server has the bCODE processing token associated with the bCODE, the merchant server 172 can forward the processing token into the financial network 178 for payment processing as previously described.

It will be apparent to the person skilled the art that the online shopping system of FIG. 15 could equally handle gift card, coupon and loyalty programs in a similar manner to that described previously. In such embodiments, the user would provide a bCODE, e.g. gift card bCODE at the client browser which would be forwarded to the bCODE translation service 176 for translation into the relevant processing token.

Because bCODEs can be delivered by any data and non data dependent delivery systems (SMS, USSD, app push/pull, social media messaging platforms), it is handset and carrier agnostic, with the scanning technology able to work in an offline environment. Thus, bCODEs systems can be readily created and deployed, allowing issuing banks and merchants to circumvent third party token service providers and the associated fees.

As has been described above, customer codes, particularly optically scannable customer codes and more particularly text based optically scannable customer codes can be used as surrogate tokens for use in a range of transactions. In one particular embodiment, the transaction process may be modified so that a single scan of a customer code can lead to multiple actions being performed.

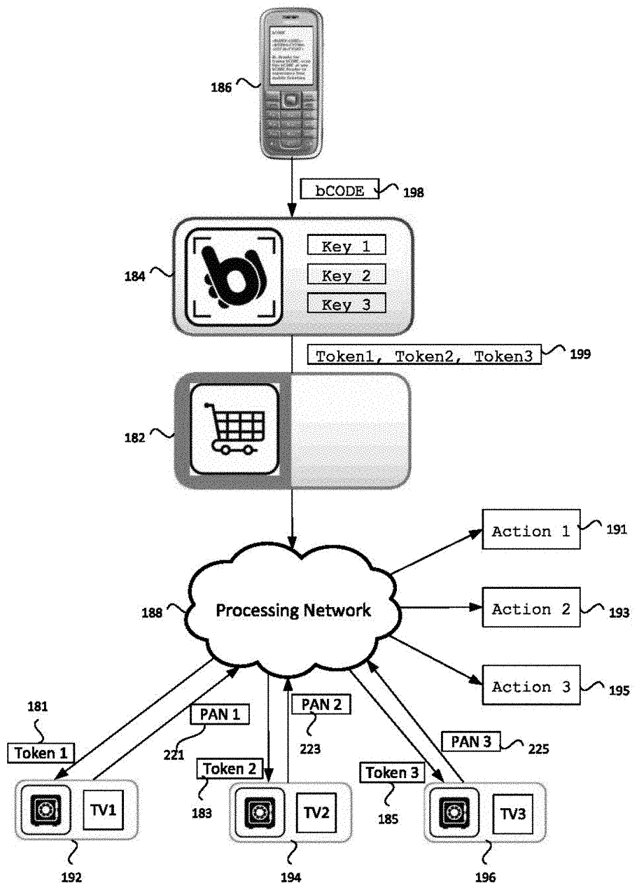

A merchant system may include a bCODE processor coupled to a merchant device. In one embodiment as depicted in FIG. 16, the merchant system may be a point of sale system in a shop premises and may include an ECR, POS device 182 or similar. The merchant system is used during a transaction between the merchant and a customer, i.e. during a purchase of goods or services of the merchant by the customer. The bCODE processor 184 may be a bCODE scanner as described above for optically reading a bCODE from a user device 186. In alternative embodiments, the merchant system may be an online system including servers and bCODE processors programmed for processing bCODEs for online transactions.

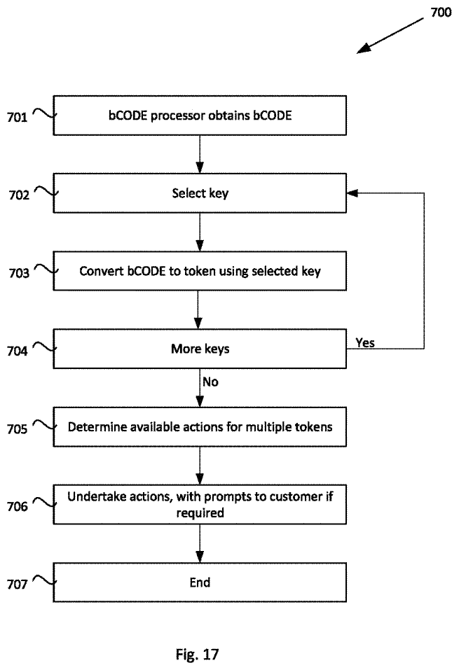

The bCODE processor 184 may be programmed with multiple keys for generating multiple processing tokens from a single bCODE. In FIG. 16, the bCODE processor is programmed with three keys, Key1, Key2 and Key3, though any number of keys may be programmed into the bCODE processor 184. FIG. 17 shows a flowchart 700 depicting a method for multi-token generation. At step 701, a bCODE is obtained from the user into the bCODE processor 184. The bCODE processor selects a first key (e.g. Key1) (step 702) and converts the bCODE to a first processing token (Token 1) 703 using the selected key, e.g. by performing a cryptographic one-way hash using Key1. If more keys are present (determination step 704) then the process returns to select the next key 702. Otherwise, if all tokens have been generated, the merchant system may determine what actions are available based on the generated tokens 705 and then proceed to undertake those actions 706, with additional prompts to the customer if required. The transaction ends at step 707.

By the process 700, the merchant system shown in FIG. 16 can acquire a single bCODE 198 and process the bCODE multiple times using multiple keys to generate multiple tokens 199, (individually, Token1 181, Token2 183, Token3 185). These tokens can then be used to undertake multiple individual actions 191, 193, 195 during the transaction, using a processing network 188 and various token vaults (TV1 192, TV2 194, TV3 196).

For example, a first hash of a bCODE using keyl may produce a financial processing token that is converted by the processing network 188 and token vault TV1 192 into a first PAN, PAN1 221. The processing network 188 uses PAN1 to authorize a payment for a purchase by the consumer at the merchant system. Simultaneously, a second hash of the bCODE using key2 may generate a loyalty program token, Token2 183 that is passed to a second token vault TV2 194 by the processing network 188 to handle customer relationship management, loyalty program rewards, points crediting, etc. A third hash using the key3 may reveal a further action (Action 3 195) that can be performed, such as a gift card action. Other actions will be apparent to the person skilled in the art.

In one embodiment, during a transaction at the merchant system, the merchant system receives a bCODE from the customer. The merchant system applies some or all of the programmed keys to the bCODE to generate a plurality of tokens. The merchant system then determines what actions are available based on the generated tokens.

The actions to be undertaken may be determined by the bCODE processor 184, the merchant device 182 and/or processing network 188, either automatically, or with prompts to the merchant, operator or customer.

Whether an action is available may depend on the validity of a respective token. It may be the case that not all tokens generated are valid. For example, the merchant system may be programmed with a loyalty program key but the customer may not be enrolled in that loyalty program with their bCODE. A generated token may either reference an invalid token vault, or may reference a valid token vault but be a token that is not represented in the respective token vault. In each case, the processing network 188 will determine that a particular token is invalid and indicate to the merchant system that the token is not valid. The merchant system may thus determine that no action corresponding to the token is available. Thus, in the loyalty program example above, an invalid loyalty program token will indicate that no loyalty program action is to be taken for the transaction. Alternatively, the merchant system may determine that instead of no action, an offer to the customer to join the loyalty program should be made.

The merchant system may be programmed to display some or all of the available actions to the customer on the merchant terminal. For example, the tokens may reveal a payment, a loyalty program and a gift card redemption. The customer may be prompted to confirm payment with the selected payment type, and may be prompted to indicate whether a gift card reward is to be redeemed on this transaction.

In one embodiment, the merchant system 182 may apply all keys to a bCODE. In an alternative embodiment, aspects of the bCODE, e.g. leading characters, may provide an indication of what keys are to be applied to the bCODE.

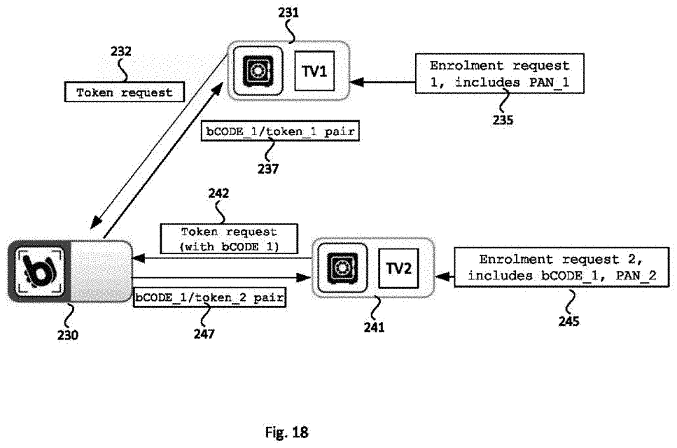

The provisioning system described above with reference to financial token provisioning (FIG. 2), gift card provisioning (FIG. 7) or CRM token provisioning (FIGS. 9, 11) may be modified to account for the one-to-many relationship of bCODEs to tokens. FIG. 18 illustrates the modified provisioning process. The initial creation of a first bCODE/token pair and assignment to a first PAN may be as described above with reference to FIGS. 2, 5, 9 and 11. For example, a user may initially enroll for financial payments through a bCODE enabled payment system. An enrolment request 235 including a primary account number (PAN_1) for an account held by the user with the financial service provider is sent to the token vault corresponding to the financial service provider, e.g. TV1 231. TV1 231 sends a token request 232 to the bCODE generator 230. The bCODE generator 230 generates a bCODE (bCODE_1) and applies a first algorithm and first key corresponding to TV1 to the bCODE to generate a processing token (token_1) within the BIN range for TV1 231. The bCODE_Vtokena_1 pair 237 is returned to token vault TV1 231. The user is issued with bCODE1 via the delivery mechanisms described previously. The bCODE_1/token_1/PAN_1 association is stored in the token vault TV1 231. At some later time, the user may enroll in a second bCODE enabled transaction system, such as a loyalty program. A second enrolment request 245 is sent to token vault for the loyalty program TV2 241. The user, having already been issued with a bCODE may submit their bCODE (bCODE_1) in the enrolment request. TV2 241 receives the bCODE as part of the enrolment process and sends a token request 242 to the bCODE generator for a processing token. The user's bCODE_1 is provided in the request 242. Instead of generating a new bCODE, the bCODE generator uses the received bCODE and applies a second algorithm and second key to generate a second processing token within the BIN range of TV2. The bCODE_1/token_2 pair 242 is returned to TV2 241. A loyalty program identifier, e.g. PAN_2, may be associated with the bCODE/token2 pair and stored in TV2 241.

This provisioning process may be repeated for any subsequent request by the user for bCODE enabled transactions.

If required, additional authorization steps may be required to verify that the user is the owner of a submitted bCODE.

In an alternative provisioning system, the bCODE system may be associated with multiple partner providers that operate multiple token vaults. Whenever a user is first enrolled to the partner program, the user may be assigned a bCODE. The bCODE may be processed at the time of enrolment into multiple processing tokens via multiple keys and the multiple bCODE/token pairs may be distributed to the multiple corresponding token vaults to await assignment of the user PAN at a later stage. When the user enrolls to a specific service provided by a specific token vault, the user's account number (PAN) may be assigned to the bCODE/token pair with additional verification steps if required to ensure that the correct assignment is created.

While reference is made to distinct token vaults, it will be appreciated by the person skilled in the art that multiple token vaults may be amalgamated into a single token vault with a bCODE having multiple token and PAN associations within the token vault.

Throughout the presently described embodiments, specific reference has been made to the use of optically scannable codes for the customer code and more particularly to the use of the Applicant's proprietary bCODEs. While bCODEs or similar text based codes have many benefits in terms of ease of delivery to customers/users, ease of scanning, minimal cost for deployment, etc., in other embodiments, the customer code does not need to be a text based code. Other forms of optically scannable code may be utilized including bar codes and two dimensional codes, e.g. QR codes. In other embodiments, the merchant systems could be configured to receive customer codes via other means, including near-field communications or manual entry forms.

Although embodiments of the present invention have been illustrated in the accompanied drawings and described in the foregoing description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols. The below listing of the claims will replace all prior versions and listings of the claims in the application. The present claim amendments are relative to the article 34 claims and not relative to the claims as originally filed

1. A transaction method including:
obtaining an optically scannable code at a merchant system during a transaction at the merchant system, wherein the merchant system includes:
an electronic cash register; and,
a reader device operatively connected to the electronic cash register; wherein, the reader device uses the optically scannable code and processes the optically scannable code using a plurality of one-way cryptographic hash keys;
processing, at the merchant system, the optically scannable code using the plurality of one-way cryptographic hash keys into a plurality of processing tokens; and,
performing, at the merchant system, at least two actions individually associated with at least two of the plurality of processing tokens.

2. The transaction method of claim 1, wherein processing the optically scannable code using the plurality of one-way cryptographic hash keys includes processing the optically scannable code using a first key to produce a financial processing token, and, wherein a first action of the at least two actions includes authorizing a payment for the transaction using the financial processing token.

3. The transaction method of claim 2, wherein authorizing a payment for the transaction using the financial processing token includes providing the financial processing token to a first token vault for conversion to a first primary account number of a financial account of the user and authorizing a financial payment for the transaction using the first primary account number.

4. The transaction method of claim 2, wherein processing the optically scannable code using the plurality of one-way cryptographic hash keys includes processing the optically scannable code using a second key to produce a Customer Relationship Management (CRM) token and wherein a second action of the at least two individual actions includes performing at least one CRM function.

5. The transaction method of claim 4, wherein the CRM token includes a loyalty program token and wherein the second action includes at least one loyalty program action.

6. The transaction method of claim 4, wherein the at least one CRM function includes crediting a points value of the transaction to a CRM account of the user using the CRM processing token.

7. The transaction method of claim 4, including applying a discount to the transaction based on an accumulated value in a CRM account associated with the CRM token.

8. The transaction method of claim 4, including providing the CRM token to a second token vault for conversion to a second primary account number of a CRM account associated with the user.

9. The transaction method of claim 1, including providing a first processing token of the plurality of processing tokens to a first token vault for conversion to a first primary account number and providing a second processing token of the plurality of processing tokens to a second token vault for conversion to a second primary account number.

10. The transaction method of claim 1, including determining a validity of one or more of the plurality of processing tokens and determining from the validity the actions that are available for the transaction.

11. A merchant system including:
an electronic cash register; and
at least one reader device operatively connected to the electronic cash register and programmed to:
obtain an optically scannable code during a transaction of the merchant system; and,
process the optically scannable code using a plurality of one-way cryptographic hash keys to produce a plurality of processing tokens;
wherein the electronic cash register is programed to:
receive the plurality of processing tokens from the reader device; and
initiate at least two transactions using at least two of the plurality of processing tokens.

12. The merchant system of claim 11, wherein the reader device is used to apply a first algorithm and first key to the optically scannable code to generate a first processing token and wherein the reader device is used to apply a second algorithm and second key to the optically scannable code to generate a second processing token.

13. The merchant system of claim 12, wherein the first processing token includes a financial processing token and a first action includes a financial transaction using the financial processing token.

14. The merchant system of claim 13, wherein the second processing token includes a loyalty program token and wherein a second action includes at least one loyalty program transaction.

15. The merchant system of claim 11, wherein the electronic cash register is in communication with a processing network including a plurality of token vaults, wherein the electronic cash register is programmed to pass a first processing token to a first token vault and wherein the electronic cash register is programmed to pass a second processing token to a second token vault.

16. The merchant system of claim 11, wherein the reader device is programmed to optically capture an image of a user device displaying the optically scannable code and process the captured image to obtain the optically scannable code.

17. The merchant system of 11, wherein the electronic cash register is programmed to determine a validity of one or more of the processing tokens and determine from the validity one or more actions that are available to be performed for the transaction.

18. The merchant system of claim 11, wherein the electronic cash register is programmed to determine the validity of the one or more processing tokens by reference to one or more token vaults.

19. The merchant system of claim 11, wherein the optically scannable code is in the form of a character sequence.

20. A reader device, adapted to be used in a merchant system, said reader device being programmed to:
obtain an optically scannable code during a transaction of the merchant system; and,
process the optically scannable code using a plurality of one-way cryptographic hash keys to produce a plurality of processing tokens;

21. (canceled)
